(19) United States
(12) Patent Application Publication
(10) Pub. No.: US 2017/0240196 A1
(43) Pub. Date: Aug. 24, 2017

(54) DISPOSABLE GROCERY CART COVER

(71) Applicant: Aris N. Strong, Aurora, CO (US)

(72) Inventor: Aris N. Strong, Aurora, CO (US)

(21) Appl. No.: 15/047,380

(22) Filed: Feb. 18, 2016

(51) Int. Cl. B62B 3/14; B43L 5/00

(52) U.S. Cl. CPC B62B 3/1436; B62B 3/1448; B62B 3/1468; B43L 5/00

(57) ABSTRACT

A disposable grocery cart cover for decreasing the risk of infection for children placed in grocery carts by providing a sanitary lining system. The grocery cart cover may include a planar cover material adapted to fit over a child seat of a grocery cart. The planar cover material may have a center portion and an outer edge portion. The grocery cart cover may also include two holes located in the center portion of the planar cover material and adapted to receive two legs. The grocery cart cover may further include two slits adapted to receive a safety strap and a drawing surface holder. A packaging system allowing disposable grocery cart covers to be distributed to grocery cart users in an efficient manner is also provided.

### BACKGROUND OF THE INVENTION

Studies have shown that shopping carts are notorious for carrying numerous germs. Children placed in shopping carts may be particularly susceptible to infection due to the high use of shopping carts as well as the age of the children. Shopping carts that are not routinely disinfected may raise safety concerns. Thus, new systems and methods for decreasing the risk of infection for children placed in shopping carts would be beneficial.

### BRIEF SUMMARY OF THE INVENTION

In one aspect of the present invention, a grocery cart cover is provided. The grocery cart cover may include a planar cover material adapted to fit over a child seat of a grocery cart. The planar cover material may have a center portion and an outer edge portion. In some embodiments, the grocery cart cover may include two holes located in the center portion of the planar cover material and may be adapted to receive two legs. In some embodiments, the grocery cart cover may also include two slits located in the center portion of the planar cover material. The two slits may be adapted to receive a safety strap. In some embodiments, the grocery cart cover may further include a drawing surface holder. The drawing surface holder may be located in the center portion of the planar cover material and may be adapted to secure an insertable drawing surface.

In some embodiments, the grocery cart cover may include a stretchable edge material occupying a portion of the outer edge portion of the planar cover material. In some embodiments, the planar cover material, the drawing surface holder, and the stretchable edge material are made from recyclable materials. In some embodiments, the drawing surface holder includes two parallel strips mounted to the center portion of the planar cover material. The two parallel strips may be adapted to receive a rectangular drawing surface by sliding the rectangular drawing surface between the two parallel strips so that the rectangular drawing surface is secured on two of its four sides.

In some embodiments, the grocery cart cover includes the rectangular drawing surface secured by the drawing surface holder. In some embodiments, the rectangular drawing surface is made from cardboard. In some embodiments, the planar cover material is rectangular and/or is made from polypropylene. In some embodiments, one or more sides of the planar cover material may be adapted to be folded into the center portion of the planar cover material so that when the one or more sides are folded the grocery cart cover is rectangular.

In one aspect of the present invention, a grocery cart cover packaging system is provided. The grocery cart cover packaging system may include a plurality of grocery cart covers connected in an end-to-end arrangement. In some embodiments, each of the plurality of grocery cart covers may include a planar cover material, two holes, two slits, and a drawing surface holder, as described previously. The grocery cart cover packaging system may also include a plurality of perforated edges dividing the plurality of grocery cart covers. In this manner, a single grocery cart cover may be detached from the plurality of grocery cart covers by severance of a single perforated edge of the plurality of perforated edges. In some embodiments, the plurality of grocery cart covers connected in an end-to-end arrangement are rolled together forming a cylindrical shape.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and various ways in which it may be practiced.

FIG. 1 illustrates a disposable grocery cart cover, according to an example embodiment described in the present disclosure.

FIGS. 2A and 2B illustrate interconnected sheets of disposable grocery cart covers, according to an example embodiment described in the present disclosure.

FIG. 3 illustrates a disposable grocery cart cover distribution and recycling system, according to an example embodiment described in the present disclosure.

FIGS. 4A and 4B illustrate interconnected sheets of disposable grocery cart covers, according to an example embodiment described in the present disclosure.

FIG. 5 illustrates an interconnected sheet of disposable grocery cart covers, according to an example embodiment described in the present disclosure.

In the appended figures, similar components and/or features may have the same numerical reference label. Further, various components of the same type may be distinguished by following the reference label by a letter that distinguishes among the similar components and/or features. If only the first numerical reference label is used in the specification, the description is applicable to any one of the similar components and/or features having the same first numerical reference label irrespective of the letter suffix.

### DETAILED DESCRIPTION OF THE INVENTION

Various example embodiments of the present disclosure will be described below with reference to the drawings constituting a part of the description. It should be understood that, although terms representing directions are used in the present disclosure, such as “front”, “rear”, “upper”, “lower”, “left”, “right”, and the like, for describing various example structural parts and elements of the present disclosure, these terms are used herein only for the purpose of convenience of explanation and are determined based on the example orientations shown in the drawings. Since the embodiments disclosed by the present disclosure can be arranged according to different directions, these terms representing directions are merely used for illustration and should not be regarded as limiting. Wherever possible, the same or similar reference marks used in the present disclosure refer to the same components.

Unless defined otherwise, all technical terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings.

The present disclosure primarily relates to systems and methods for decreasing the risk of infection for children placed in grocery carts by providing a sanitary lining systems for grocery carts that are easy to use and recyclable. The present disclosure also provides an packaging system that allows the grocery cart covers to be distributed to grocery cart users in an efficient manner.

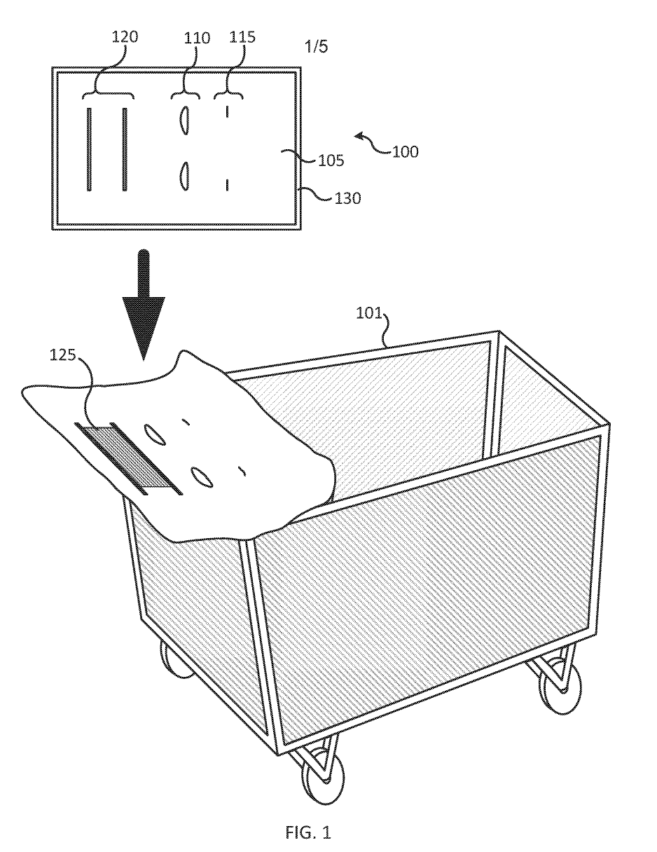

FIG. 1 illustrates a disposable grocery cart cover 100, according to an example embodiment described in the present disclosure. The disposable grocery cart cover 100 may comprise a recyclable, disposable cover material 105 that may be adapted to fit over the child seat of a grocery cart 101. The cover material 105 may be composed of any one of a variety of materials. For example, the cover material 105 may be paper, cardboard, or a plastic material such as polypropylene, polystyrene, or low-density polyethylene. The primary purpose of the cover material 105 is to provide a sanitary lining that prevents a child seated in the grocery cart 101 from making physical contact with any exposed surface of the grocery cart 101. This may be accomplished by selecting a size for the cover material 105 as appropriate to cover all exposed surfaces within reach of a child seated in the grocery cart 101.

In some embodiments, the cover material 105 may be planar and rectangular. However, the cover material 105 need not be rectangular and may take on any one of a variety of shapes. In some embodiments, the cover material 105 may be a single color, such as white. In other embodiments, the cover material 105 may be used as an advertising space. For example, different company logos may be placed in locations where parents are likely to look. In some embodiments, the cover material 105 may have a number of different features on its center portion and on the edge portion surrounding its center portion. As shown in FIG. 1, the cover material 105 may have holes 110 placed near each other for allowing a child's feet to pass through the holes 110 while seated. In some embodiments, the holes 110 may be cut as slits without removal of any portion of the cover material 105. In some embodiments, holes 110 may be cut as circles, ovals, or squares, therefore removing some portion of the cover material 105. The location of the holes 110 may be chosen so as to fit comfortably a child's legs while sitting. The spacing between the holes 110 may be dependent on the average spacing between a child's legs while sitting, and may be, for example, 4.0 inches. Other embodiments may have larger or shorter spacing, such as 2.5 inches, 3.0 inches, 3.5 inches, 4.5 inches, 5.0 inches, and the like. The spacing between each of the holes 110 and the edge portion of the cover material 105 may be dependent on the size of the cover material 105 that is selected, and may be equidistant on both sides.

In some embodiments, the disposable grocery cart cover 100 may include two slits 115 located on the center portion of the cover material 105. The slits 115 may be placed in a location of the grocery cart cover 100 to allow the safety strap on the grocery cart 101 to extend through one of the slits 115, over the child's lap, and through the other of the slits 115. The spacing between the slits 115 may be dependent on the average spacing between the two ends of grocery cart safety straps, and may be, for example, 8.0 inches. Other embodiments may have larger or shorter spacing, such as 6.5 inches, 7.0 inches, 7.5 inches, 8.5 inches, 9.0 inches, and the like. The spacing between each of the slits 115 and the edge portion of the cover material 105 may be dependent on the size of the cover material 105 that is selected, and may be equidistant on both sides. In some embodiments, the disposable grocery cart cover 100 may not have slits for a safety strap but rather may have a safety strap built into the cart cover itself. For example, a safety strap composed of the same or different material as the cover material 105 may be connected to the cover material 105 at the same or different locations where the slits 115 are shown in FIG. 1.

In some embodiments, the disposable grocery cart cover 100 may include a drawing surface holder 120 located on the center portion of the cover material 105. The drawing surface holder 120 may be adapted to secure a drawing surface 125 using a variety of methods. For example, as shown in FIG. 1, the drawing surface holder 120 may include two parallel strips mounted to the center portion of the cover material 105 that are adapted to receive a drawing surface 125 by sliding the drawing surface 125 between the two parallel strips so that it is secured on two of its four sides. The two parallel strips may be made from the same material as the cover material 105 or from a different material. As another example, the drawing surface holder 120 may include only a single strip that allows the drawing surface 125 to rest above the single strip. As another example, the drawing surface holder 120 may include an adhesive that allows the drawing surface 125 to be pressed directly into the cover material 105 to be secured. As another example, the drawing surface holder 120 may include an area composed of a high friction material that allows a drawing surface 125 to rest on the material without slipping. There are numerous other embodiments of drawing surface holder 120 not listed here that may facilitate the present disclosure.

In some embodiments, the disposable grocery cart cover 100 may include an edge material 130 located on the edge portion of the cover material 105. In some embodiments, the purpose of the edge material 130 is to secure the disposable grocery cart cover 100 to the grocery cart 101 so that any exposed surfaces within a child's reach are covered while the child is seated. The edge material 130 may be any one of a number of materials, including stretchable fabrics and enclosed elastics. For example, the edge material 130 may be a two-way stretch fabric that stretches in the tangential direction to the edge portion of the cover material 105. As another example, the edge material 130 may include an enclosed rubber band that allows the edge material 130 to stretch and tighten around features of the grocery cart 101. It should be noted that the edge material 130 need not occupy the entire edge portion of the cover material 105 as shown in FIG. 1. In some embodiments, the edge material 130 may occupy only 50%, 25%, or 10% of the edge portion. Furthermore, in some embodiments, the edge material 130 may only occupy the corners of the disposable grocery cart cover 100. For example, the edge material 130 may be four strings located at four corners of the disposable grocery cart cover 100, allowing parents to secure the device by tying the strings to different features of the grocery cart 101.

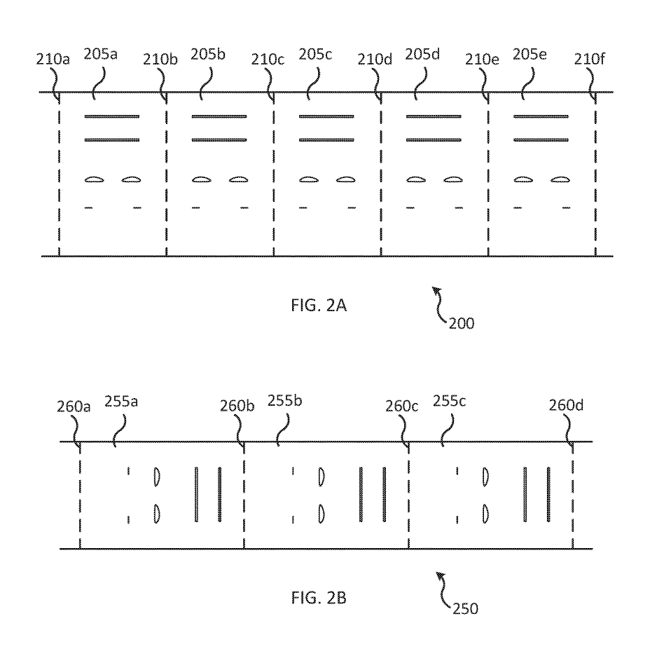

FIGS. 2A and 2B illustrate interconnected sheets 200 and 250 of disposable grocery cart covers, according to an example embodiment described in the present disclosure. Both of the shown interconnected sheets 200 and 250 include a plurality of disposable grocery cart covers 205 and 255 connected in an end-to-end arrangement. The individual disposable grocery cart covers are divided by a plurality of perforated edges 210 and 260. In FIG. 2A, interconnected sheet 200 is shown in an end-to-end arrangement with perforated edges 210 denoted with dashed lines. Disposable grocery cart covers 205 are connected along a long edge, as opposed to disposable grocery cart covers 255 which are connected along a short edge. Interconnected sheet 250, as shown in FIG. 2B, is also shown in an end-to-end arrangement with perforated edges 260 denoted with dashed lines. When manufactured in this manner, disposable grocery cart covers may be easily packaged by rolling the sheets into a cylindrical shape for later distribution. When a parent desires to use a disposable grocery cart cover, he/she may select a single disposable grocery cart cover from an interconnected sheet of disposable grocery cart covers and sever a single perforated edge. Whether interconnected sheet 200 or 250 is selected for a given packaging system may depend upon the distribution system, as will be discussed below.

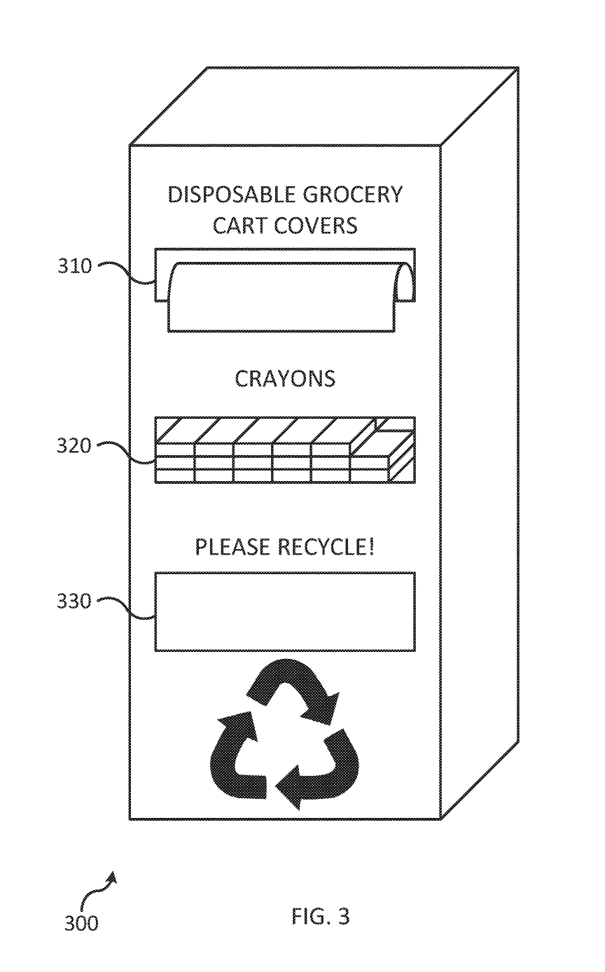

FIG. 3 illustrates a disposable grocery cart cover distribution and recycling system 300, according to an example embodiment described in the present disclosure. The disposable grocery cart cover distribution and recycling system 300 allows parents to easily select a single disposable grocery cart cover from an interconnected sheet of disposable grocery cart covers and sever a single perforated edge to remove it for use. Grocery stores and other facilities that employ shopping carts may place one or more disposable grocery cart cover distribution and recycling systems 300 near an entrance. In some embodiments, parents may remove a disposable grocery cart cover from slot 310, take a box of crayons from slot 320, and afterward place the used disposable grocery cart cover in slot 330 for recycling. In some embodiments, the disposable grocery cart cover distribution and recycling system 300 may have multiple slots and/or differently sized slots from which to remove disposable grocery cart covers. In some embodiments, additional slots may be available for drawing surfaces, such as drawing surface 125 of FIG. 1. For example, one slot may contain drawing surfaces with a super heroes theme designed for boys, and another slot may be contain drawing surfaces with a princesses theme designed for girls. In some embodiments, the drawing surfaces may contain advertising materials.

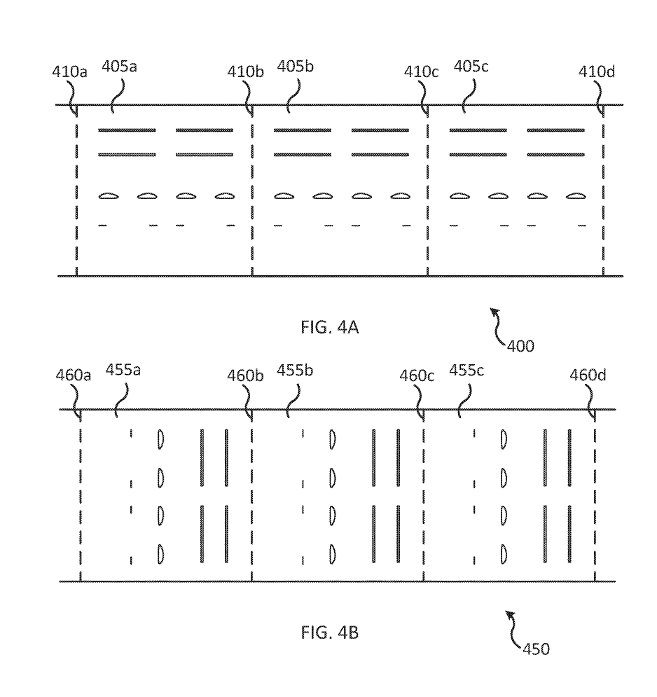

FIGS. 4A and 4B illustrate interconnected sheets 400 and 450 of disposable grocery cart covers, according to an example embodiment described in the present disclosure. Interconnected sheets 400 and 450 differ from those shown in FIG. 2 by fitting grocery cart designs where two children are allowed to sit instead of one. Interconnected sheets 400 and 450 are similar to interconnected sheets 200 and 250 in most other respects. Both of the shown interconnected sheets 400 and 450 include a plurality of disposable grocery cart covers 405 and 455 connected in an end-to-end arrangement. The individual disposable grocery cart covers are divided by a plurality of perforated edges 410 and 460. In FIG. 4A, interconnected sheet 400 is shown in an end-to-end arrangement with perforated edges 410 denoted with dashed lines. Disposable grocery cart covers 405 are connected along a long edge, as opposed to disposable grocery cart covers 455 which are connected along a short edge. Interconnected sheet 450, as shown in FIG. 4B, is also shown in an end-to-end arrangement with perforated edges 460 denoted with dashed lines.

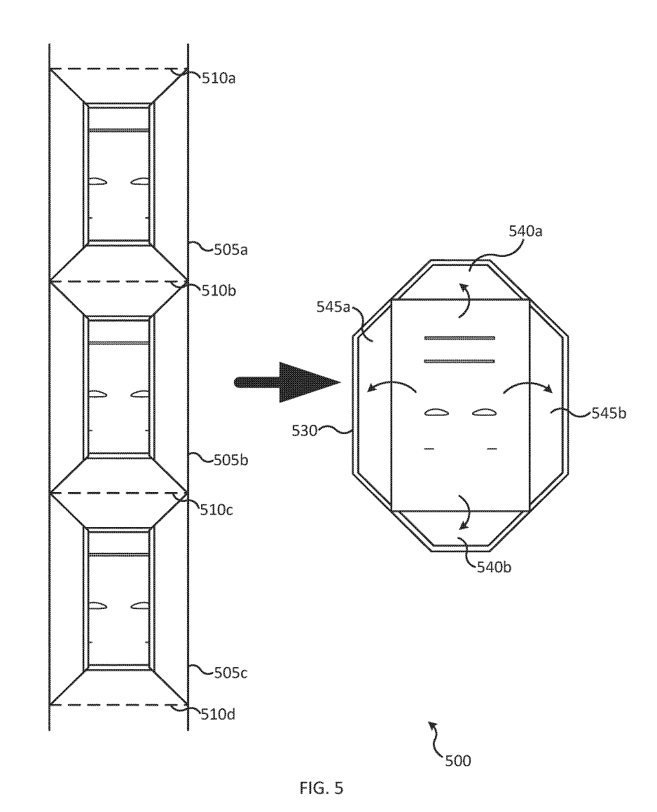

FIG. 5 illustrates an interconnected sheet 500 of disposable grocery cart covers, according to an example embodiment described in the present disclosure. In some embodiments, interconnected sheet 500 includes a plurality of disposable grocery cart covers 505 which have folded sides that may be expanded (i.e., folded outwards) upon severance of perforated edges 510. Disposable grocery cart cover 530 shows an expanded view of one of the plurality of disposable grocery cart covers 505. Disposable grocery cart cover 530 has foldable top panels 540 and foldable side panels 545 that may be expanded (i.e., folded outwards, as indicated by the arrows in FIG. 5) upon severance of a perforated edge. Using this technique, disposable grocery cart covers of a variety of shapes may be used without being constrained by the packaging technique, which generally requires that the packaged grocery cart covers have at least one flat edge for attachment to other packaged grocery cart covers. However, in some embodiments, interconnected sheet 500 need not comprise disposable grocery cart covers with at least one flat edge.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a user” includes a plurality of such users, and reference to “the processor” includes reference to one or more processors and equivalents thereof known to those skilled in the art, and so forth.

Also, the words “comprise”, “comprising”, “contains”, “containing”, “composed”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. A grocery cart cover comprising:
a planar cover material adapted to fit over a child seat of a grocery cart, the planar cover material having a center portion and an outer edge portion;
two holes located in the center portion of the planar cover material adapted to receive two legs;
two slits located in the center portion of the planar cover material adapted to receive a safety strap; and
a drawing surface holder located in the center portion of the planar cover material adapted to secure an insertable drawing surface.

2. The grocery cart cover of claim 1, further comprising:
a stretchable edge material occupying a portion of the outer edge portion of the planar cover material.

3. The grocery cart cover of claim 2, wherein the planar cover material, the drawing surface holder, and the stretchable edge material are made from recyclable materials.

4. The grocery cart cover of claim 3, wherein the drawing surface holder includes two parallel strips mounted to the center portion of the planar cover material adapted to receive a rectangular drawing surface by sliding the rectangular drawing surface between the two parallel strips such that the rectangular drawing surface is secured on two of its four sides.

5. The grocery cart cover of claim 4, further comprising:
the rectangular drawing surface secured by the drawing surface holder.

6. The grocery cart cover of claim 5, wherein the rectangular drawing surface is made from cardboard.

7. The grocery cart cover of claim 3, wherein the planar cover material is rectangular.

8. The grocery cart cover of claim 3, wherein the planar cover material is made from polypropylene.

9. The grocery cart cover of claim 3, wherein one or more sides of the planar cover material are adapted to be folded into the center portion of the planar cover material such that when the one or more sides are folded the grocery cart cover is rectangular.

10. A grocery cart cover packaging system comprising:
a plurality of grocery cart covers connected in an end-to-end arrangement, wherein each of the plurality of grocery cart covers includes:
a planar cover material adapted to fit over a child seat of a grocery cart, the planar cover material having a center portion and an outer edge portion;
two holes located in the center portion of the planar cover material adapted to receive two legs;
two slits located in the center portion of the planar cover material adapted to receive a safety strap; and
a drawing surface holder located in the center portion of the planar cover material adapted to secure an insertable drawing surface; and
a plurality of perforated edges dividing the plurality of grocery cart covers, such that a single grocery cart cover may be detached from the plurality of grocery cart covers by severance of a single perforated edge of the plurality of perforated edges.

11. The grocery cart cover packaging system of claim 10, wherein each of the plurality of grocery cart covers further includes:
a stretchable edge material occupying a portion of the outer edge portion of the planar cover material.

12. The grocery cart cover packaging system of claim 11, wherein the planar cover material, the drawing surface holder, and the stretchable edge material are made from recyclable materials.

13. The grocery cart cover packaging system of claim 12, wherein the drawing surface holder includes two parallel strips mounted to the center portion of the planar cover material adapted to receive a rectangular drawing surface by sliding the rectangular drawing surface between the two parallel strips such that the rectangular drawing surface is secured on two of its four sides.

14. The grocery cart cover packaging system of claim 13, wherein each of the plurality of grocery cart covers further includes:
the rectangular drawing surface secured by the drawing surface holder.

15. The grocery cart cover packaging system of claim 14, wherein the rectangular drawing surface is made from cardboard.

16. The grocery cart cover packaging system of claim 12, wherein the planar cover material is rectangular.

17. The grocery cart cover packaging system of claim 12, wherein the planar cover material is made from polypropylene.

18. The grocery cart cover packaging system of claim 12, wherein one or more sides of the planar cover material are adapted to be folded into the center portion of the planar cover material such that when the one or more sides are folded the grocery cart cover is rectangular.

19. The grocery cart cover packaging system of claim 12, wherein the plurality of grocery cart covers connected in an end-to-end arrangement are rolled together forming a cylindrical shape.

20. A grocery cart cover comprising:
a planar cover material adapted to fit over a child seat of a grocery cart, the planar cover material having a center portion and an outer edge portion;
two holes located in the center portion of the planar cover material adapted to receive two legs;
two slits located in the center portion of the planar cover material adapted to receive a safety strap;
a drawing surface holder located in the center portion of the planar cover material adapted to secure an insertable drawing surface;
a stretchable edge material occupying a portion of the outer edge portion of the planar cover material;
wherein the planar cover material, the drawing surface holder, and the stretchable edge material are made from recyclable materials;
wherein the drawing surface holder includes two parallel strips mounted to the center portion of the planar cover material adapted to receive a rectangular drawing surface by sliding the rectangular drawing surface between the two parallel strips such that the rectangular drawing surface is secured on two of its four sides; and
wherein one or more sides of the planar cover material are adapted to be folded into the center portion of the planar cover material such that when the one or more sides are folded the grocery cart cover is rectangular.
